(19) United States
(12) Patent Application Publication
(10) Pub. No.: US 2006/0135485 A1
(43) Pub. Date: Jun. 22, 2006

(54) Microbicidal compositions and their use

(76) Inventors: David W. Ashworth, Nottinghamshire (GB); Jurgen R. Huff, Ludwigshafen (DE); Mohammed S. Qureshi, Nottinghamshire (GB); David V. Roper, Nottinghamshire (GB); Lawrence A. Staniforth, Nottinghamshire (GB); Dieter Zeller, Speyer (DE); Walter G. Guthrie, Leicestershire (GB)

Correspondence Address: CONNOLLY BOVE LODGE & HUTZ, LLP, P O BOX 2207, WILMINGTON, DE, 19899, US

(21) Appl. No.: 10/529,825

(22) PCT Filed: Sep. 25, 2003
(86) PCT No.: PCT/GB03/04176

§ 371 Date: Nov. 28, 2005

(30) Foreign Application Priority Data
Oct. 2, 2002 (GB) 0222843.5

(51) Int. Cl. A01N 51/00; A01N 43/66; A01N 43/80; A01N 43/50

(52) U.S. Cl. 514/149; 514/241; 514/372; 514/389; 514/393

(57) ABSTRACT

A composition comprising a potassium salt of N′-hydroxy-N-cyclohexyldiazenium oxide (KHDO) and a diluent is useful for killing fungi. Such a composition but which additionally includes at least one of certain other fungicidally active components is useful for combating microorganisms in general. Such other fungicidally active component is selected from: alcohols, isothiazolones, activated halogen compounds, formaldehyde release compounds, phenolic compounds, aldehydes, acids and esters, biphenyls, urea derivatives, O-acetals, O-formals, N-acetals, N-formals, benzamidines, phthalimides, pyridine derivatives, quaternary ammonium and phosphonium compounds, amines, amphoteric compounds, dithiocarbamates, compounds containing active oxygen and mixtures of any of these.

This invention relates to microbicidal compositions and their use.

Harmful microorganisms cause damage to many materials, productions and processes. New microbicidal compositions for preventing this are needed, especially compositions which are effective at high pH values.

Many microbicidal compositions for combating microorganisms are commercially available. For example, microbicides known to be effective at high pH values are quaternary ammonium compounds such as cetyl pyridium chloride, di-N-decyl-dimethylammonium chloride or N-hexadecyl-N,N-trimethylammonium bromide. However, these compounds generate foam and are difficult to handle.

For many years, it has been known (GB-A-815538) that alkali metal salts of N-alkyl-N-nitrohydroxylamines (also referred to as N′-hydroxy-N-alkyl diazenium oxides) are effective in inhibiting fungal growth.

GB-A-2106392 discloses the use of mixtures of the alkali metal (especially potassium) salt of N′-hydroxy-N-cyclohexyldiazenium oxide with a triallyl tin compound for combating bacterial and fungal growth for the treatment of textiles, plastics materials, adhesives, building materials, paper, leather, drilling and cutting aids and circulating cooling water.

GB-A-1438154 discloses the use, for combating fungi and insects, of a mixture of methyl (2-benzimidazole)carbamate with, specifically, the aluminium salt of N-nitro-N-cyclohexyl hydroxylamine, while EP-A-0358672 discloses a method of controlling organisms which grow under moist conditions, such as algae and lichen, by treatment with certain metal salts, notably copper or tin salts, or amine salts of N′-hydroxy-N-cyclohexyldiazenium oxide.

However, all of the above documents are concerned with controlling, i.e. preventing the growth of, microorganisms.

We have found surprisingly that fungi can be killed by the application thereto of, specifically, the potassium salt of N′-hydroxy-N-cyclohexyl-diazenium oxide (KHDO).

We also found surprisingly that a mixture of KHDO with any of a wide range of other biocides may exhibit a synergistic effect against a broad spectrum of microorganisms.

According to a first aspect, the invention provides the use, for killing fungi, of a composition comprising salt KHDO and a diluent.

According to a second aspect, the invention provides a method of killing fungi, which method comprises administering to the fungi a composition comprising KHDO and a diluent.

According to a third aspect, the invention provides the use, for combating microorganisms of a composition comprising (A) KHDO and (B) another additional microbicidally active component selected from a range of compounds given below. Such use may result in the killing of the microorganisms.

According to a fourth aspect, the invention provides a microbicidal composition comprising (A) KHDO and (B) another additional microbicidally active component selected from a range of compounds B, given below. Application of such compositions may result in the killing of the microorganisms.

In the third and fourth aspects of the invention the range of compounds from which component (B) is selected is as follows:

1. Alcohols, including halogenated alcohols.

2. Isothiazolones.

3. Activated halogen compounds.

4. Formaldehyde release compounds.

5. Phenolic compounds.

6. Aldehydes.

7. Acids and esters.

8. Biphenyls.

9. Urea derivatives.

10. O-acetals, O-formals.

11. N-acetals, N-formals.

12. Benzamidines.

13. Phthalimides.

14. Pyridine derivatives.

15. Quaternary ammonium and phosphonium compounds.

16. Amines.

17. Amphoteric compounds.

18. Dithiocarbamates.

19. Compounds containing active oxygen such as peroxide.

Such compounds may be present, as component (B), either alone or as a mixture of any of these compounds.

Examples of alcohol compounds which may serve as the microbicidally effective component (B) are 2-bromo-2-nitropropane-1,3-diol and 2-(hydroxymethyl)-2-nitro-1,3-propanediol. Examples of isothiazolone compounds are 5-chloro-2-methyl-2H-isothiazol-3-one (CIT), 2-methyl-2H-isothiazol-3-one (MIT), 1,2-benzisothiazol-3(2H)-one, 2-n-octyl-2H-isothiazol-3-one, 4,5-dichloro-2-octyl-2H-isothiazol-3-one and 2-butyl-benzo[d]isothiazol-3-one and mixtures thereof with one another, including a mixture of CIT with MIT or mixtures of CIT or MIT with any of 1,2-benzoisothlazol-3(2H)-one, 2-octyl-2H-isothiazol-3-one, 4,5-dichloro-2-octyl-2H-isothiazol-3-one and 2-butyl-benzo[d]isothiazol-3-one. Examples of other compounds are dibromodicyanobutane, β-bromo-β-nitrostyrene, 7a-ethyldihydro-1H,3H,5H-oxazolo[3,4-c]oxazole, tetrahydro-1,3,4,6-tetrakis(hydroxymethyl)-imidazo[4,5-d]imidazole-2,5(1H,3H)-dione, 1,3-dimethyl-5,5-dimethylhydantoin, diazolidinyl ureas and imidazolidinyl ureas, N′-(3,4-dichlorophenyl)-N,N-dimethyl urea, 3,3′-methylenebis(5-methyl-oxazolidine), iodo-2-propynylbutylcarbamate, 2-sodiumsulfidopyridine-N-oxide and its metal salts, dibromonitrilopropionamide, tetrakishydroxymethylphosphonium salts, ortho-phenylphenol and salts of ortho-phenylphenol, 1-(3-chloroallyl)-3,5,7-triaza-1-azoniaadamantane salts, (5-chloro-2,4-dichlorophenoxy)phenol, 3,4,4′-trichlorocarbanilide (triclocarban), o-benzo-p-chlorophenol, p-hydroxybenzoates, 2-(thiocyanomethylthio) benzothiazole, 3,5-dimethyl-1,3,5-thiadiazinane-2-thione, 2,4-dichlorobenzyl alcohol, chlorothalonil, methylenebis(thiocyanate), peracetic acid, 4,4-dimethyl-oxazolidine, phenoxyethanol, phenoxypropanol, 2,6-dimethyl-m-dioxan-4-ol-acetate, glutaraldehyde, glyoxal, ortho-phthalaldehyde, 4-(2-nitrobutyl)-morpholine, triazines such as 1,3,5-tris-(2-hydroxyethyl)-1,3,5-hexahydrotriazine, quaternary ammonium compounds such as benzalkoniumchloride, polyhexamethylenebiguanide salts, poly(oxyethylene(dimethylimino)ethylene(dimethylimino)-ethylene dichloride, chlorhexidine gluconate, chloroisocyanurates, halogenated hydantoins such as 1-bromo-3-chloro-5,5-dimethylhydantoin and polamines such as polyvinylamine- and polyethylene imine derivatives.

Preferred components (B) are 2-bromo-2-nitropropane-1,3-diol, 2-methyl-2H-isothiazol-3-one, 1,2-benzisothiazol-3 (2H)-one, 2-n-octyl-2H-isothiazol-3-one, a mixture of 5-chloro-2-methyl-2H-isothiazol-3-one with 2-methyl-2H-isothiazol-3-one, dibromodicyanobutane, tetrahydro-1,3,4,6-tetrakis(hydroxymethyl)-imidazo[4,5-d]imidazole-2,5(1H,3H)-dione, 3,3′-methylenebis(5-methyl-oxazolidine), 1,3-dimethyl-5,5-dimethylhydantoin, tetrakishydroxymethylphosphonium salts, ortho-phenylphenol and salts of ortho-phenylphenol, 1-(3-chloroallyl)-3,5,7-triaza-1-azoniaadamantane salts, (5-chloro-2,4-dichlorophenoxy)phenol, 3,4,4′-trichlorocarbanilide (triclocarban), p-hydroxybenzoates, 2-(thiocyanomethylthio) benzothiazole, 3,5-dimethyl-1,3,5-thiadiazinane-2-thione, 2,4-dichlorobenzyl alcohol, chlorothalonil, methylenebis(thiocyanate), phenoxyethanol, phenoxypropanol, triazines such as 1,3,5-tris-(2-hydroxyethyl)-1,3,5-hexahydrotriazine, quaternary ammonium compounds such as benzalkoniumchloride, polyhexamethylene biguanide salts, poly(oxyethylene(dimethyimino)ethylene(dimethylimino) ethylene dichloride, chlorhexidine gluconate, chloroisocyanurates and polyvinylamines, especially the polyamines disclosed in WO-A-97/32477.

Surprisingly it was found that KHDO is especially suitable when applied in combination with 2-bromo-2-nitropropane-1,3-diol, 1,2-benzisothiazol-3(2H)-one, 1,3,5-tris-(2-hydroxyethyl)-1,3,5-hexahydrotriazine, 5-chloro-2-methyl-2H-isothiazol-3-one, 2-methyl-2H-isothiazol-3-one, tetrahydro-1,3,4,6-tetrakis(hydroxymethyl)-imidazo[4,5-d]imidazole-2,5(2H,3H)-dione, 1,3-dimethyl-5,5-dimethylhydantoin and polyvinylamines, especially a polyamine containing from 80-100%, more preferably 90-98 wt %, vinylamine units and from 0 to 20 wt % more preferably, 2-10 wt %, vinyl formamide units.

Most preferably, the component used in combination with KHDO is stable at high pH values.

As mentioned above, KHDO, even as sole microbicidally active component, can be used not only to combat the growth of microorganisms, including viruses but also to kill certain microorganisms, especially fungi, more especially Aspergillus niger and Chaetomium globosum, and indeed yeasts, e.g. Saccharomyces cerevisiae, Candida albicans and Malassezia furfur, the yeast which causes dandruff, and certain bacteria such as Pseudomonas fluorescens, Pseudomonas aeruginosa, Alcaligenes faecalis and Staphylococcus aureus.

Indeed, we found surprisingly that KHDO had a much stronger effect against fungi than had been previously appreciated and is active against a broader spectrum of microorganisms, especially certain spoilage bacteria.

Accordingly, by application of KHDO, it is thus now possible to kill, or at least control the growth of microorganisms without using toxic heavy metals such as lead or mercury.

Thus, KHDO can be used to preserve metal working fluids, process fluids (e.g. water treatment in cooling towers or pulp and paper processing) and to protect goods such as leather, textiles, textile auxiliaries, leather auxiliaries, cosmetics, cleaners, lubricants, metal working fluids, detergents, paper, cardboard, plastics, building materials, pigment preparations, paint formulations, adhesives and sealants against microbial attack. Preferably the KHDO is used in industrial processes such as cooling towers and pulp and paper processing. Another preferred use of the KHDO is the in-can preservation of formulated products such as paints and cosmetic products. Furthermore, as indicated above, surprisingly it was found that KHDO is very effective in the protection of products, articles and formulations against certain spoilage bacteria, especially Pseudomonas fluorescens, Pseudomonas aeruginosa, Alcaligenes faecalis and Staphylococcus aureus, fungi, especially Aspergillus niger, Chaetomium globosum and Saccharomyces cerevisiae and especially the dandruff causing yeast Malassezia furfur which makes the use of KHDO in cosmetics products, another preferred application. The microorganisms mentioned above are ubiquitous in the applications mentioned but normally hard to fight. To date, it was not known that KHDO is effective against these difficult organisms.

KHDO may be formulated into a concentrate based either on water or an organic solvent and optionally one or more co-formulants such as emulsifiers or pH-adjusting additives. Preferred formulations are water based and may contain low, more preferably no, volatile organic compounds (VOC). Concentrates of KHDO may contain between 5 and 60%, more preferably between 10 and 45%, still more preferably between 20 to 40%, especially 20 to 30%, by weight of total concentrate, of KHDO.

In application, KHDO is preferably used so as to provide a final concentration of from 0.001 to 10%, more preferably 0.01 to 5%, especially 0.02 to 0.5%, by weight of the liquid medium (including any liquid environment to be treated).

In particular, although the pH of the KHDO concentrate may vary from 2-12, as can that of the medium to be treated, concentrated alkaline formulations are particularly effective against microorganisms. Accordingly, it is preferred that the concentrate and more especially the treated product has a pH of at least 4, more preferably at least 7, still more preferably at least 8, especially 8-12.

A preferred product has a pH adjusted to at least 7, more preferably at least 8 using potassium hydroxide. In contrast with most microbicides which can be used at high pH, such as quaternary ammonium compounds, KHDO does not generate foam and is easy to handle.

KHDO can be formulated into e.g. pastes, emulsions or solutions or put onto solid carriers. If required surfactants, emulsifiers, chelants, solubilizers/solvents, salts, corrosion inhibitors, dyes, fragrances, anti-foaming agents or dispersants are included either alone or in combination.

As mentioned above, KHDO, as a component (A), may be rendered even more effective by admixture with another microbicidally effective component (B), as defined above.

Compositions embodying the invention including such combinations have a particularly strong microbicidal effect and a particularly broad spectrum and can therefore be used for combating efficiently many undesirable microorganisms. Such combined active components and formulations produced therefrom can act by a chemical route to destroy, discourage or render harmless, harmful organisms, prevent harmful effects or may act in other ways. Formulations embodying the invention may be used to prevent microbial infestation of industrial materials, in other words they can be used for in-can preservation. They serve also as microbicidal finishers of products, in other words they can be used for film conservation.

“Industrial materials” are to be understood as non-living materials, as they are attacked in technical-industrial processes. Industrial materials which can be protected from microbial damage or destruction by formulations embodying the invention are, for example, finishings, drilling oils, dispersions, emulsions, dyes, adhesives, lime, lacquers, pigment preparations, paper, paper processing materials, textiles, textile processing materials, leather, leather processing materials, wood, coating materials, anti-fouling colours, plastics articles, cosmetics, washing and cleaning materials, cooling lubricants, hydraulic fluids, joint sealing compounds, window cement, thickening solutions, fleeces as well as carpet layers and other materials which can be attacked or destroyed by microorganisms.

Likewise, formulations embodying the invention can be used in water treatment. Water treatment is understood as the addition of formulations to processing water, for example, combating slime in the paper industry and for control of harmful organisms in the sugar industry. They prevent or control the growth of microorganisms in cooling circulation systems, air humidification or in drilling and conveying fluid in the oil industry.

Formulations embodying the invention can be used for disinfection of, for example, bottles, instruments, hands, waste, water outflow and in washing. Here, particular examples which can be mentioned are in hospitals, nursing homes and old peoples homes, where disinfection of the above mentioned materials and objects plays a particular role, because the patients mostly have the least resistance to infection.

Microorganisms which are capable of infesting and even damaging or destroying industrial materials are bacteria, fungi (e.g. yeasts and moulds) and their spores, algae and slime organisms. Preferably the formulations embodying the invention are effective against bacteria and fungi, especially yeasts and moulds.

Examples of gram-positive bacteria are Micrococcaceae, Streptococcaceae, Bacilli, Lactobacillaceae, Actinomycetales, especially Mycobacterium, Dermatophilus, Nocardiaceae, Streptoomyces and Corynebacterium. Examples of gram-negative microorganisms are Spirochaetales (e.g. Spirochaetaceae and Leptospiraceae), Pseudomonadaceae, Legionellaceae, Neisseriaceae, Enterobacteriaceae, Vibrionaceae, Pasteurellaceae, Bacteroidaceae, Veillonellaceae, Rickettsiaceae, Bartonellaceae and Chlamydiaceae, as well as Brucellaceae.

Examples of yeasts include the families Cryptococcaceae and Sporobolomycetaceae in which are found human pathogenic kinds of Candida, Trichospores as well as Cryptococcus neoformans. Examples of these are Candida albicans and Saccharomyces cerevisiae.

An example of a mould within the family zygomycetes is Mucorales; examples of the family Hypomycetes are Aspergillus and Penicillium and an example of the family Bodariales is Neurospora. The representatives of moulds most mentioned are, for example, Alternaria alternata, Aspergillus niger and Penicillium funiculosum.

In a composition embodying the invention comprising a combination of (A) and (B), the respective amounts of the components (A) and (B) in the composition are preferably 1 to 99 wt % of (A) and 1 to 99 wt % of (B), more preferably 10 to 90 wt % of (A) and 90 to 10% wt % of (B) especially 40 to 60 wt % of (A) and 40 to 60 wt % of (B).

As in the case of a composition containing KHDO as sole microbicidally active component, a composition embodying the invention comprising respective components (A) and (B) may be formulated into a concentrate based either on water or an organic solvent and optionally one or more co-formulants such as emulsifiers or pH-adjusting additives. Again, preferred formulations are water based and may contain low, more preferably no, volatile organic compounds (VOC). The concentrates may contain between 5 and 60%, more preferably between 10 and 45%, still more preferably between 20 to 40%, especially 20 to 30%, by weight of total concentrate, of the combination of respective components (A) and (B).

In application, the combination of active components (A) and (B) is preferably used so as to provide a final concentration of from 0.001 to 10%, more preferably 0.01 to 5%, especially 0.02 to 0.5%, of (A) and (B), by weight of the liquid medium (including any liquid environment to be treated).

In particular, although the pH of the concentrate may vary from 2-12, as can that of the medium to be treated, concentrated alkaline formulations are particularly effective against microorganisms. Accordingly, it is preferred that the concentrate and more especially the treated product has a pH of at least 4, more preferably at least 7, still more preferably at least 8, especially 8-12.

A preferred product has a pH adjusted to at least 7, more preferably at least 8, using potassium hydroxide.

Compositions embodying the invention comprising a combination of components (A) and (B), in dependence upon their chemical and physical properties, can be made up into the usual formulations and preparations as, for example, emulsions, suspensions, dispersions, solutions, powders, pastes or in combination with carrier materials.

To the combinations can optionally be added surface active agents such as surfactants, e.g. emulsifiers, for example, anionic surfactants such as alkylsulfonate and ethersulfate; nonionic surfactants such as fatty alcohol ethoxylate, fatty alcohol esterthiolate, sorbitan ester and polyalkylene glycol; and amphoteric surfactants; chelanats, for example, ethylenediaminetetraacetic acid, nitrilotriacetic acid and methylglycinediacetic acid; solubilizers and/or solvents, for example alcohols such as ethanol, n-propanol and i-propanol, and glycols, for example, propylene glycol and polypropylene glycol, acids and bases, for example, phosphoric acid and caustic soda, inorganic salts and/or other additives, as for example, corrosion inhibitors, anti-foaming agents, dyestuffs and fragrances, either alone or in combination with one another.

It is especially surprising that a composition embodying the invention comprising a combination of (A) KHDO with (B) another microbicidally effective component can exhibit such a strong effect and indeed, in certain cases, a synergistic effect against a broad spectrum of microorganisms.

Such strong, or even synergistic, effects may be observed against, for example, Staphylococcus aureus, Escherichia coli, Proteus mirabilis, Citrobacter freundii, Pseudomonas fluorescens, Pseudomonas aeruginosa, Alcaligenes faecalis, Candida albicans, Saccharomyces cerevisiae, Alternaria alternata, Aspergillus niger, Penicillium funiculosum and Chaetomium globosum.

For example, a combination of (A) KHDO and (B) a polyamine consisting of 95 wt % vinylamine, and 5 wt % vinylformamide, units has a very strong effect against Pseudomonas aeruginosa (PSA), Candida albicans (CA), Proteus mirabilis (PRM), Staphylococcus aureus (STA), Aspergillus niger (ASN) and Escherichia coli (EC) and exhibits a remarkable synergistic effect against STA, PRM, PSA and CA.

Indeed, it is particularly advantageous to use this combination against Pseudomonas aeruginosa (PSA), because the Synergy factor I of 0.13 is especially low. Pseudomonas aeruginosa is a pathogenic agent resulting in hospital infections.

Similarly, a combination of (A) KHDO with (B) 1,2-benzisothiazol-3(2H)-one (BIT) exhibits an excellent synergistic effect against each of Pseudomonas aeruginosa, Staphylococcus aureus, Candida albicans and Aspergillus niger.

Especially strong biocidal activity can be observed for each of the following:

1. KHDO as sole active component.

2. (A) KHDO+(B) 2-bromo-2-nitropropane-1,3-diol (BNPD), commercially available as Bronopol.

3. (A) KHDO+(B) 1,2-benzisothiazol-3(2H)-one (BIT).

4. (A) KHDO+(B) a polyvinylamine consisting of 95 wt % vinylamine and 5 wt % vinylformamide units.

5. (A) KHDO+(B) benzalkonium chloride.

6. (A) KHDO+(B) triazine.

Embodiments of the invention will now be described in more detail with reference to the following Examples.

### EXAMPLE 1

Preservation Loading Test for KHDO/BIT Combination

Styrene Butadiene Emulsions were inoculated with 1×10⁶ of the test culture, stored for 7 days at 25° C. and then a semi-quantitative determination of colony forming units was carried out. This loading test was carried out with a representative bacteria (Pseudomonas aeruginosa ATCC 9027), a representative yeast (Candida albicans ATCC 10231) and a representative mould (Aspergillus niger ATCC 16404) over consecutive weeks until the product has been subjected to (at least) three separate loadings of each culture type. The concentration of preserving agent at which no recovery of the test organisms was observed is the end point of the test and adequacy of preservation is assumed.

Test Results:

| Butofan DS 2258, pH 6.8 | |
|---|---|
| Active Ingredient | Concentration (ppm of |
| | active) |
| KHDO | 1000 |
| BIT | 200 |
| KHDO / BIT blend (1:1 ratio) | 75 |
| KHDO / BIT blend (3:1 ratio) | 125 |
| Butofan 305D, pH 6.9 | |
| KHDO | 11500 |
| BIT | 250 |
| KHDO / BIT blend (1:1 ratio) | 37.5 |
| KHDO / BIT blend (3:1 ratio) | 150 |

Firstly, it is surprising that KHDO even when applied as sole active component in neutral conditions was able not only to inhibit but actively kill a representative range of spoilage microorganisms (bacteria, yeasts and moulds) in a typical polymer emulsion.

Secondly, it was surprising that combinations of the two predominantly antifungal actives KHDO and BIT were able to provide effective broad spectrum control in a typical polymer emulsion at levels well below those which would be expected by simple additive effect.

### EXAMPLE 2

Effects of KHDO/BNPD Combination against Bacteria and Fungi

Materials

0.1% Peptone water+0.85% Salt diluent (Oxoid)

Tryptone Soya Agar Plates (Oxoid)

Tryptone Soya Agar (Oxoid)

Sabouraud Dextrose Agar Plates (Oxoid)

Sabouraud Dextrose Agar (Oxoid)

Test Organisms

Pseudomonas aeruginosa NCIB 8626

Staphylococcus aureus NCIB 9518

Methods

Dosing Regime

An unpreserved acrylate based polymer latex dispersion was dispensed as 8×40 ml aliquots and dosed to give the concentrations detailed in Table 1.

Test Regime

The samples were inoculated and checked for test organism recovery in 7-day intervals at. All samples underwent four consecutive insults.

Total Viable Aerobic Count (TVC)

Serial dilution series of the samples were made in 0.1% Peptone diluent. 1 ml volumes of these dilution series were plated in Tryptone Soya Agar (TSA) to enumerate aerobic bacteria and Sabouraud Dextrose Agar (SAB) to enumerate yeasts and moulds. The TSA plates were incubated at 30±1° C. and the SAB plates at 25±1° C. for at least 5 days.

Multiple Challenge Test

Each sample variant was dispensed as 2×20 ml aliquots into sterile containers. Aliquot 1 was inoculated with 0.2 ml of mixed bacterial inocula (Pseudomonas aeruginosa and Staphylococcus aureus). Aliquot 2 was inoculated with mixed fungal inocula (A. niger & C. albicans). The inoculum concentration gave an in product concentration of approximately 1.0×10⁶ cfu ml⁻¹. The test preparations were stored at 25±1° C. during the test period.

After 7-days incubation at 25±1° C., a semi-quantitative determination of colony forming units was carried out by streaking 10 μl of each sample onto the surface of TSA plates to enumerate aerobic bacteria and Sabouraud Dextrose Agar (SAB) to enumerate yeast's and moulds. The TSA plates were incubated at 30±1° C. for 3 days and the SAB plates at 25±1° C. for at least 5 days. After each 7-day sampling the aliquots were re-incoluated until four challenges were achieved.

| | | | | |
|---|---|---|---|---|
| Acrylate | Pass | Pass | Pass | Pass |
| 100 ppm BNPD | | | | |
| 375 PPM khdo | | | | |
| Acrylate | Pass | Pass | Pass | Pass |
| 100 ppm BNPD | | | | |
| 750 ppm KHDO | | | | |
| Acrylate | Fail | Fail | Fail | Fail |
| Unpreserved | | | | |
| Inoculated | | | | |

### EXAMPLE 3

Effect of KHDO/Polyvinylamine Copolymer Combination Against Various Microorganisms.

Test methods:

Microbiocides and microbiocidal properties were determined experimentally. Very well suited test methods are described in detail in the German Society for Hygiene and Microbiology (GGHM) for the examination of disinfectants.

In order to determine the MIC, culture tube dilution tests were carried out according to the “regulations for the examination and evaluation of chemical disinfection procedures (Edition 1.1.81, procedures slightly modified)” using a kerosene peptide-soya bean meal peptide medium. The dilution was carried out with water of standardised hardness without further agents such as surfactants. The adjustment of the pH values to 7.2±0.2 was carried out with 0.1 mol/NaOH or 0.1 mol/HCl. The gradation of test concentrations was made according to the concentration steps proposed by the GGHM. The evaluation was carried out after a 72 hour incubation at 36° C.

The following table gives the strain numbers of the microorganisms:

Microorganisms Examined

| | |
|---|---|
| Staphylococcus aureus (STA) | ATCC 6538 |
| Escherichia coli (EC) | ATCC 11229 |
| Proteus mirabilis (PRM) | ATCC 14153 |
| Pseudomonas aeruginosa (PSA) | ATCC 15442 |
| Candida albicans (CA) | ATCC 10231 |
| Aspergillus niger (ASN) | ATCC 16404 |

Formulation

One part polyvinylamine, consisting of 95 wt % vinyl units and 5 wt % vinylformamide units with a K-value of 90 were mixed with 4.2 parts cyclohexyldiazeniumdioxy potassium. This mixture had a solids content of 14.7%. The effectiveness was determined according to the abovementioned methods.

Results

| | | | | MIC | | | |
|---|---|---|---|---|---|---|---|
| | | | | Cyclo- | | Calculated | |
| | | | MIC | hexyl- | | proportion | |
| | | | Poly- | diazenium | | of Cyclo- | |
| | | | vinyl- | dioxy | Calculated | hexyl- | |
| | | MIC | amine | potassium | proportion | diazenium | |
| | MIC | Example | [ppm | [ppm | of Poly- | dioxy | |
| | Example | [ppm | a.i.] | a.i.] | vinylamine | potassium | I = a/A + |
| | [%] | a.i.] | A | B | a | B | b/B |
| STA | 0.25 | 370 | 600 | 750 | 70 | 300 | 0.52 |
| EC | 0.25 | 370 | 1600 | 350 | 70 | 300 | 0.90 |
| PRM | 0.25 | 370 | 6000 | 750 | 70 | 300 | 0.41 |
| PSA | 0.25 | 370 | 2000 | 3000 | 70 | 300 | 0.13 |
| CA | 0.1 | 150 | 1600 | 350 | 30 | 120 | 0.36 |
| ASN | 0.1 | 150 | 20000 | 175 | 30 | 120 | 0.68 |

MIC stated here gives the minimal effective concentration, in which a.i. (active ingredient) means the active component.

The synergy factor I<1 is given in order to show how the effect of the combination is raised. The lower the value than 1, the larger is the synergistic effect.

1-21. (canceled)

22. A process for protecting an industrial material from fungal infestation or fungal growth comprising contacting the industrial material with an effective amount of a water-based composition comprising a potassium salt of N′-hydroxy-N-cyclohexyldiazenium oxide (KHDO) and water, wherein the water-based composition has a pH of at least 4, and thereby killing any fungus on or in the industrial material.

23. The process of claim 1, wherein the KHDO is the sole fungicidally active component of the water-based composition.

24. The process of claim 1, wherein the water-based composition further comprises a second fungicidally active component selected from the group consisting of 2-bromo-2-nitropropane-1,3-diol (BNPD); 1,2-benzisothiazol-3 (2H)-one (BIT); a polyvinylamine consisting of 95% vinylamine and 5% vinylformamide units by weight (PVA); and benzalkonium chloride (BACI).

25. The process of claim 24, wherein the sole fungicidally active component of the water-based composition in addition to KHDO is selected from the group consisting of BNPD, BIT, PVA and BACI.

26. A process for protecting an industrial material from microbial infestation comprising contacting the industrial material with an effective amount of a water-based composition comprising (A) a potassium salt of N′-hydroxy-N-cyclohexyldiazenium oxide (KHDO) and (B) a second microbicidally active component selected from the group consisting of 2-bromo-2-nitropropane-1,3-diol (BNPD); 1,2-benzisothiazol-3 (2H)-one (BIT); a polyvinylamine consisting of 95% vinylamine and 5% vinylformamide units by weight (PVA); and benzalkonium chloride (BACI), wherein the water-based composition has a pH of at least 4.

27. The process of claim 26, wherein the sole microbicidally active component of the water-based composition in addition to KHDO is selected from the group consisting of BNPD, BIT, PVA and BACI.

28. The process of claim 26, wherein microorganisms are killed.

29. A water-based microbicidal composition for preventing microbial infestation of an industrial material from microorganisms, which composition comprises (A) a potassium salt of N′-hydroxy-N-cyclohexyldiazenium oxide (KHDO) and (B) a second microbicidally active component selected from the group consisting of 2-bromo-2-nitropropane-1,3-diol (BNPD); 1,2-benzisothiazol-3 (2H)-one (BIT); a polyvinylamine consisting of 95% vinylamine and 5% vinylformamide units by weight (PVA), and benzalkonium chloride (BACI), wherein the composition has a pH of at least 4.

30. The composition of claim 29, wherein the sole microbicidally active component of the composition in addition to KHDO is selected from the group consisting of BNPD, BIT, PVA and BACI.

31. The composition of claim 29, wherein the respective amounts of components (A) and (B) in the composition, by weight of the total amount of (A) and (B), are (A) 1 to 99 wt % and (B) 1 to 99 wt %.

32. The composition of claim 29, wherein the respective amounts of the components (A) and (B) are (A) 40 to 60 wt % and (B) 40 to 60 wt %.

33. The composition of claim 29 that is in the form of a paste, emulsion or solution.

34. The composition of claim 29 having a pH of at least 7.

35. The composition of claim 34 having a pH of from 8 to 12.
